(19) United States
(12) Patent Application Publication
(10) Pub. No.: US 2010/0189862 A1
(43) Pub. Date: Jul. 29, 2010

(54) MACHINE FOR LAMINATING SOFT DOUGHS FOR PASTA

(75) Inventor: Pietro Massi, Senigallia (IT)

Correspondence Address: SEED INTELLECTUAL PROPERTY LAW GROUP PLLC, 701 FIFTH AVE, SUITE 5400, SEATTLE, WA, 98104, US

(73) Assignee: ITALIANA TEKNOLOGIE S.R.L., Senigallia (IT)

(21) Appl. No.: 12/665,484

(22) PCT Filed: Jun. 16, 2008
(86) PCT No.: PCT/IB08/52367

§ 371 Date: Dec. 18, 2009

(30) Foreign Application Priority Data
Jun. 18, 2007 (IT) TO2007A000430

(51) Int. Cl. A21D 6/00; A23P 1/00

(52) U.S. Cl. 426/502; 99/450.1

(57) ABSTRACT

A machine configured to laminate a flour-based dough includes a support structure, at least one pair of counter-rotating lamination rollers, for example, with a diameter equal to or greater than 250 mm, carried by the support structure, and a driving device operable to drive the lamination rollers for rotation with a given difference in the rotational speeds thereof, which difference is between 3% and 7%, for example, equal to 5%. The machine further includes a non-motorized conveyor belt arranged to be set into motion by the lamination roller rotating faster than the other lamination roller.

### BACKGROUND

1. Technical Field

The present invention relates to a machine for laminating soft dough for pasta production.

A machine of the above-defined type, also known as rolling machine, makes it possible to obtain a base sheet which can be used as such for pasta production or be subjected to subsequent calibration or thinning operations depending on the desired product.

2. Description of the Related Art

A rolling machine for flour-based soft doughs is known from Patent Application N. MC2003A000151 in the Applicant's name and includes a support structure, a pair of lamination rollers with a diameter equal to or greater than 250 mm, whose axes of rotation are parallel to each other and are arranged in a horizontal plane, and a pair of geared motors each operable to drive a respective roller. The rollers are spaced from each other so as to delimit a gap therebetween, through which gap the dough to be laminated is transformed into a sheet. The distance between the rollers, and hence the size of the gap, can be varied continuously to adjust the thickness of the sheet obtained in a range from a few tenths of millimeter to some millimeters, typically up to 10 mm. The machine is fed simply by pouring a suitable amount of dough in a funnel-shaped space defined between the rollers and debouching at its bottom into the aforesaid gap.

### BRIEF SUMMARY

An improved rolling machine for flour-based soft doughs is provided with respect to the one known from the above-discussed document, which has a simpler structure and a better operation and in particular enables to control the outflow of the sheet.

A rolling machine for flour-based soft doughs according to an embodiment includes a support structure, at least one pair of counter-rotating lamination rollers carried by the support structure, and a driving device or assembly configured to drive the lamination rollers and rotate them. The driving device or assembly is configured to impose a given difference in the rotational speeds of the lamination rollers.

### BRIEF DESCRIPTION OF THE SEVERAL VIEWS OF THE DRAWINGS

The features and the advantages of a rolling machine according to embodiments of the present disclosure will become apparent from the following detailed description, given purely by way of non-limiting example with reference to the attached drawings, in which:

FIG. 1 is an isometric view of a machine for laminating flour-based soft doughs for the production of pasta according to one embodiment;

FIG. 2 is a side view of the machine of FIG. 1;

FIG. 3 is a cross-sectional view of the machine of FIG. 2 viewed along line III-III;

FIG. 4 is an isometric view of a machine for laminating flour-based soft doughs according to one embodiment;

FIG. 5 is a side view of the machine of FIG. 4;

FIG. 6 is a cross-sectional view of the machine of FIG. 5 viewed along line VI-VI;

FIG. 7 is an exploded isometric view of an embodiment of a machine for laminating flour-based soft doughs for the production of pasta; and

FIG. 8 is a cutaway view of a lamination roller and of the associated drum motor forming part of the machine of FIG. 7, according to one embodiment.

### DETAILED DESCRIPTION

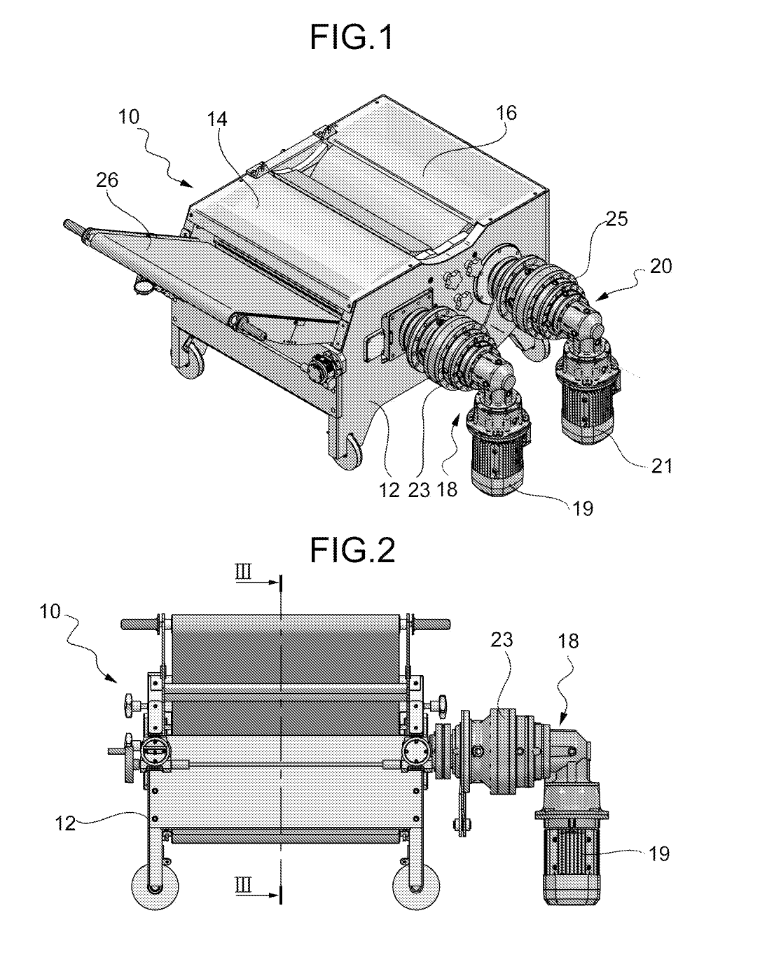

With reference first to FIGS. 1 to 3, a machine for laminating flour-based soft doughs for the production of pasta, hereinafter for brevity's sake referred to as rolling machine, is generally indicated 10 and includes:

a support structure or base 12;

a pair of lamination rollers 14 and 16, having preferably but not necessarily a diameter equal to or greater than 250 mm;

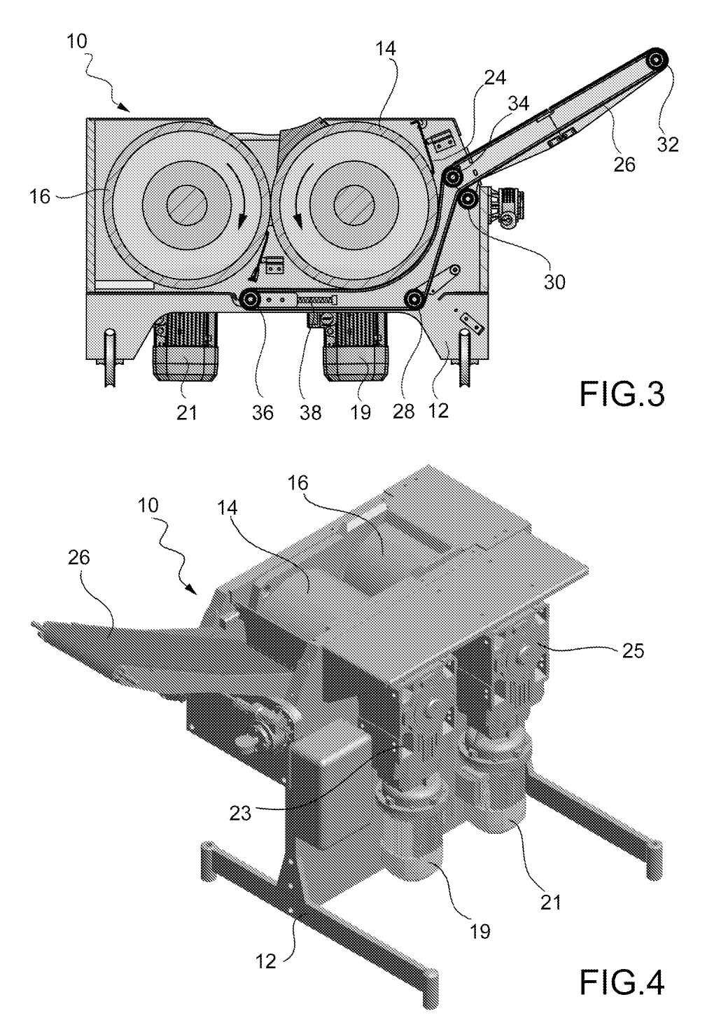

a pair of geared motor units 18 and 20 operable to drive the rollers 14 and 16 for rotation in opposing directions (as indicated by arrows in FIG. 3); and

a control unit (not shown) for controlling the geared motor units 18 and 20 to set the rotational speed of the rollers 14 and 16.

As can be seen from the sectioned view of FIG. 3, the axes of the rollers 14 and 16 are parallel to each other and are arranged in a horizontal plane. A certain minimum distance (not noticeable in the figure) is provided between the lateral surfaces of the rollers 14 and 16, whereby a gap is defined between the rollers through which the dough to be laminated is transformed into a sheet. The distance between the axes of the rollers 14 and 16, and hence the size of the gap, can be continuously varied by adjusting means, for instance of the same type as those illustrated in the patent application cited in the introductory part of the description, in order to adjust the thickness of the sheet obtained in a range usually from some tenths of millimeter to some millimeters (typically up to 10 mm).

The geared motor units 18 and 20 each include a respective vertical-axis electric motor 19 and 21 and a respective angle gear reducer 23 and 25 interposed between the motor 19 and 21 and the associated roller 14 and 16.

The control unit is arranged to control the electric motors 19 and 21 of the geared motor units 18 and 20 so as to impose a given difference in the rotational speeds of the two rollers 14 and 16, for example between 3% and 7%, preferably equal to 5%. It is to be taken into account that the rotational speeds of the two lamination rollers 14 and 16 are in the order of a few revolutions per minute.

The speed difference between the two lamination rollers 14 and 16 can be governed for example by one or more Programmable Logic Controller (PLC) integrated in the inverters which control the electric motors 19 and 21. Alternatively, it is possible to use control drives for brushless motors or PLCs associated to DC electric motors or also variable-speed motors provided with encoders governed by PLCs. According to a non-illustrated variant of construction, a single geared motor unit may be provided which drives both the lamination rollers through sets of gears having numbers of teeth suitably selected in such a manner that the desired angular speed difference between the two rollers is obtained. According to a further non-illustrated variant of construction, the two rollers may have different diameters and be driven at the same angular speed, a difference between the tangential speeds of the two rollers being ensured also in this case.

Imposing a difference between the tangential speeds of the two rollers 14 and 16, be it obtained by virtue of different angular speeds or of different diameters, makes it possible to cause the sheet to leave automatically the machine on the side of the roller rotating faster than the other (in the illustrated example the roller 14), preferably from the upper part of that roller, towards the subsequent processing stages.

A scraper 24 serving to make the detachment of the sheet from the roller easier is arranged close to the point of detachment of the sheet from the roller 14. The fact that the sheet leaves the machine from the upper part thereof makes it possible, among other things, to avoid the need of arranging the scrapers in the lower part of the machine beneath the gap separating the two rollers. Now, the scraper 24 is in fact arranged above the plane of the axes of the rollers and is therefore easy to reach by the user for cleaning and disassembling operations.

A further advantage is given by the fact that the sheet leaves the machine at the right height for the subsequent processing steps.

According to a further aspect, the machine 10 includes a non-motorized conveying belt 26, which is set into motion directly by contact with the lamination roller 14 which rotates faster than the other. The belt 26 is wound around return rollers 28, 30, 32, 34 and 36 and leaves the machine laterally above the plane of the axes of rotation of the rollers 14 and 16. The belt 26 is held under tension by means of a tensioning device 38 associated to the return roller 36 and is thus urged, with its pass extending between the return rollers 34 and 36, against the cylindrical lateral surface of the lamination roller 14, the layer of sheet which leaves the gap 22 and is attached to the lamination roller 14 being interposed between the belt 26 and the cylindrical lateral surface of the lamination roller 14 when the machine is working. The belt 26 is thus set into motion directly by the lamination roller 14, with no need of special driving mechanisms. Advantageously, the return rollers 28, 30, 32, 34 and 36 can be disassembled by hand, thereby making it easier to disassemble the belt and clean the machine.

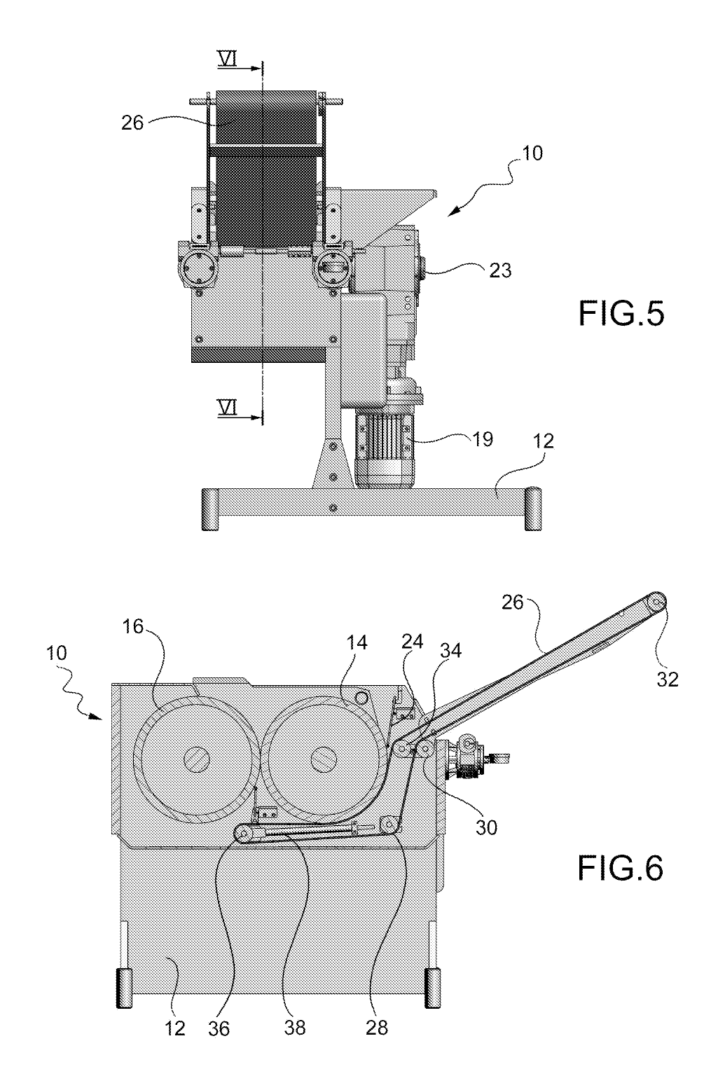

FIGS. 4 to 6 illustrate a variant of construction of the machine previously described with reference to FIGS. 1 to 3, which differs substantially only in the configuration of the support structure or base 12. In place of a double-shoulder base, such as the one of the machine of FIGS. 1 to 3, a single-shoulder base is in fact provided in this case. Apart from that, the above description still applies. It is to be noted that the same reference numerals have been used in FIGS. 4 to 6 to indicate parts and elements identical or corresponding to those of FIGS. 1 to 3.

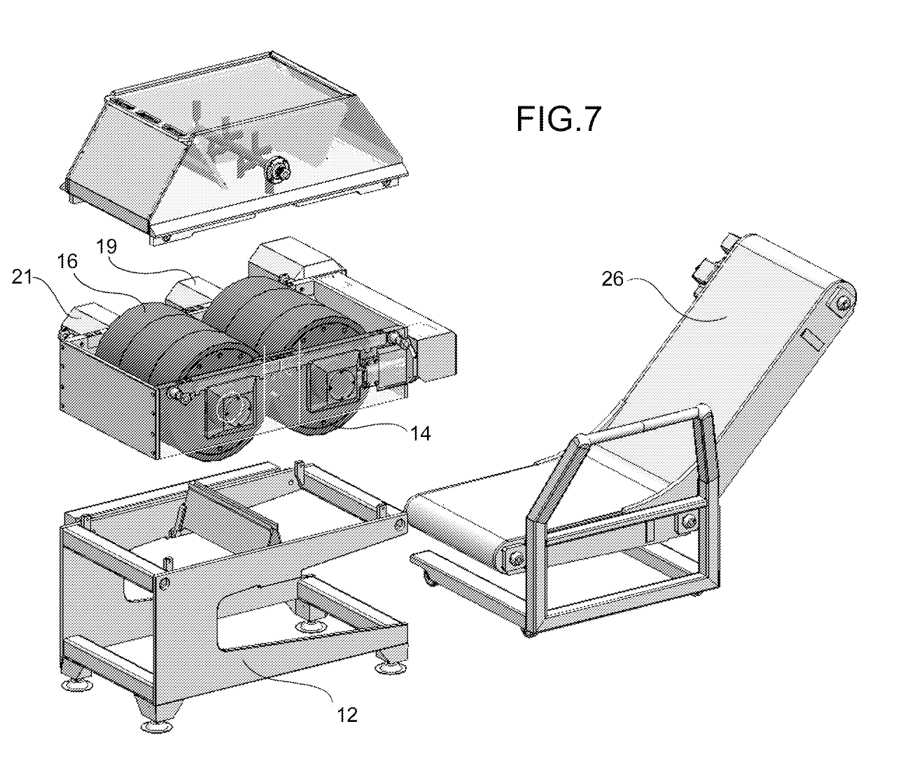

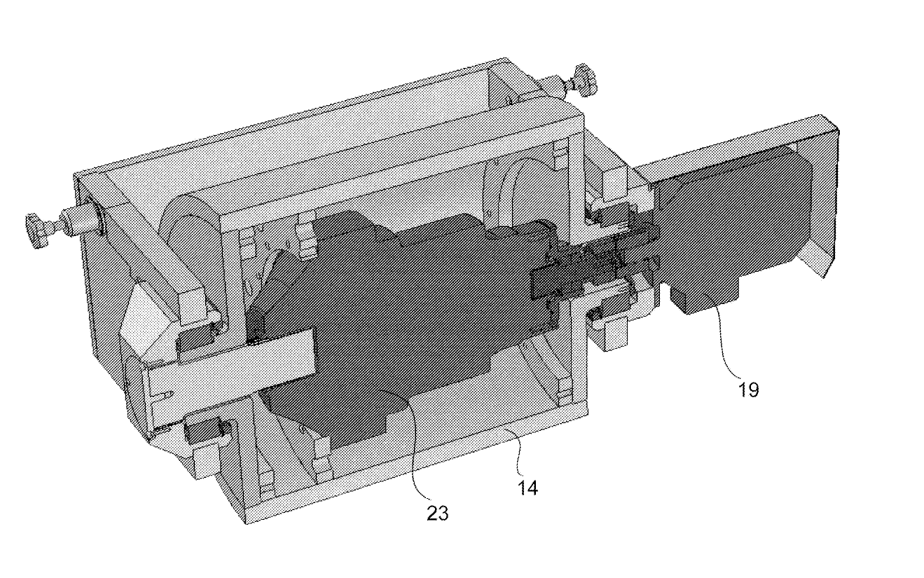

An embodiment of a machine for laminating flour-based soft doughs for the production of pasta is illustrated in FIG. 7, where parts and elements identical or corresponding to those of FIGS. 1 to 6 have been given the same reference numerals.

In this embodiment the support structure or base 12 advantageously has a C-like configuration, which is open to the side on which the belt 26 leaves the machine. This C-like configuration C allows to install easily fittings for transforming the sheet produced by the machine, such as for example thinning calibrators or calibrators provided with longitudinal and transverse cutting units for the production of long pasta and of pieces of sheet.

Moreover, as can be seen in FIG. 8, according to this second embodiment the electric motors 19 and 21 which drive the lamination rollers 14 and 16 are arranged coaxially, rather than orthogonally, to the respective reduction gears 23 and 25 and these latter are arranged each inside the respective roller. Each electric motor, reduction gear and roller assembly thus forms a so-called drum motor. This solution has the advantage of allowing to cleanse, and therefore to safely and fully sanitize, the whole machine.

In the embodiment illustrated in FIG. 7, the belt 26 is a conventional motorized belt, but it is however clearly possible to replace such a belt with the non-motorized belt previously described in connection with the embodiment of FIGS. 1 to 3.

Naturally, the principle of the invention remaining unchanged, embodiments and manufacturing details may vary widely from those described and illustrated purely by way of non-limiting example.

It is clear for example that the idea of imposing a given speed difference between the lamination rollers may be applied also to a rolling machine comprising more than one pair of lamination rollers, as described for example in Patent Application N. MC2003A000151 mentioned in the introductory part of the description. In this case, in fact, it will be sufficient, for each pair of co-operating lamination rollers, to make the roller on the side of which the sheet is required to leave the machine to rotate at a higher speed.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A machine configured to laminate a flour-based soft dough, the machine comprising:
a support structure;
at least one pair of counter-rotating lamination rollers carried by the support structure; and
a driving device to rotate the lamination rollers;
the driving device configured to impose a difference in the rotational speeds of the lamination rollers.

2. The machine according to claim 1 wherein the speed difference between the lamination rollers is between 3 percent and 7 percent.

3. The machine according to claim 1 wherein said driving device includes a pair of geared motors, each associated with a respective lamination roller and each controlled by an inverter, and wherein the speed difference between the lamination rollers is governed by at least one programmable logic controller (PLC) integrated in the inverters.

4. The machine according to claim 3 wherein each geared motor includes an electric motor and a reduction gear coaxial to the respective lamination roller and wherein the reduction gear is housed inside the respective lamination rollers.

5. The machine according to claim 1 wherein said driving device includes a single geared motor and sets of gears associated each to a respective lamination roller.

6. The machine according to claim 1 wherein the lamination rollers have different diameters and wherein said driving device is configured to drive the lamination rollers for rotation at the same angular speed.

7. The machine according to claim 1, further comprising a scraper associated to the fastest lamination roller of said pair of lamination rollers.

8. The machine according to claim 7 wherein the scraper is arranged on the side of the fastest lamination roller opposite to the other lamination roller and above the axis of rotation of the first lamination roller.

9. The machine according to claim 1, further comprising a non-motorized conveyor belt arranged to be set into motion by the fastest lamination roller.

10. The machine according to claim 9, further comprising return rollers around which the conveyor belt is wound and a tensioning device associated with one of the return rollers, in such a manner that a pass of the conveyor belt extending between said return roller on which the tensioning device acts, and the following return roller is urged against the cylindrical lateral surface of the fastest lamination roller.

11. The machine according to claim 9 wherein the support structure has a C-like configuration, which is open to the side on which the conveyor belt leaves the machine.

12. The machine according to claim 1, further comprising an adjusting device to adjust the distance between the axes of rotation of said pair of rollers.

13. A method for producing sheets for the production of pasta starting from a flour-based soft dough, comprising the step of laminating the dough by using a machine according to Claim 1.
